(19) United States
(12) Patent Application Publication
(10) Pub. No.: US 2013/0032377 A1
(43) Pub. Date: Feb. 7, 2013

(54) INSULATED WIRE AND METHOD OF MANUFACTURING THE SAME

(71) Applicants: Shigehiro MORISHITA, Hitachi (JP); Takanori YAMAZAKI, Mito (JP); Hideto MOMOSE, Hitachiota (JP)

(72) Inventors: Shigehiro MORISHITA, Hitachi (JP); Takanori YAMAZAKI, Mito (JP); Hideto MOMOSE, Hitachiota (JP)

(73) Assignee: HITACHI CABLE, LTD., Tokyo (JP)

(21) Appl. No.: 13/564,265

(22) Filed: Aug. 1, 2012

(30) Foreign Application Priority Data
Aug. 1, 2011 (JP) 2011-168274

(51) Int. Cl. H01B 3/30; H01B 13/14

(52) U.S. Cl. 174/120 SR; 427/58; 427/496

(57) ABSTRACT

An insulated wire includes a conductor, and an insulation covering layer around the conductor. The insulation covering layer includes a resin composition containing a resin (A) including at least one of a polyphenylene sulfide resin and a polyetheretherketone resin and a resin (B) containing a polyethylene. The resin composition has a storage elastic modulus at 150° C. of not less than 1×10⁵ Pa and not more than 1×10⁹ Pa, and a store elastic modulus at 300° C. of not less than 1×10⁴ Pa and not more than 1×10⁸ Pa.

The present application is based on Japanese patent application No. 2011-168274 filed on Aug. 1, 2011, the entire contents of which are incorporated herein by reference.

### BACKGROUND OF THE INVENTION

1. Field of the Invention

The invention relates to an insulated wire and, in particular, an insulated wire used for a coil of electrical equipment such as a rotating electrical machine or a transformer, and to a method of manufacturing the insulated wire.

2. Description of the Related Art

A conventional insulated wire used for a coil of electric equipment such as a rotating electrical machine or a transformer generally has a structure in which an outer periphery of a conductor shaped to have a cross section suitable for the intended use and matching a shape of a coil such as a round shape or a rectangular shape, etc., is covered with a single or plural layers of insulation coverings, as typified by an enamel covered insulated wire.

A method of manufacturing such a conventional insulated wire includes a method in which an insulating coating material formed by dissolving a resin in an organic solvent is applied to an outer peripheral surface of a conductor and is then baked, and a method in which a pre-mixed resin composition is extruded on an outer peripheral surface of a conductor.

In recent years, improvement in mechanical characteristics of an insulated wire, such as adhesion and abrasion resistance, etc., is required in order to meet a demand for size reduction of electric equipments or to withstand severe processing stress. In addition, inverter control and higher voltage use have been developed due to demand for higher efficiency and higher output of electric equipments. As a result, an operating temperature of a coil which is built in electric equipment tends to be higher than before and the insulated wire is thus required to have high heat resistance.

Since higher voltage such as inverter surge voltage is applied to the coil in the electric equipment, an insulation covering of the insulated wire may be deteriorated/damaged due to occurrence of partial discharge. In order to prevent deterioration/damage of the insulation covering caused by the partial discharge, an insulation covering with higher partial discharge inception voltage is being developed. A method in which a resin having a low relative dielectric constant is used for an insulation covering and a method in which an insulation covering is thickened are used in order to increase the partial discharge inception voltage of the insulation covering.

As an example, an insulation covering material for a winding wire configured to lower relative dielectric constant of the insulation covering by applying an insulating coating material containing a fluorine-based polyimide resin with a specific structure to a conductor has been proposed (see, e.g., JP-A-2002-56720). In the case of JP-A-2002-56720 in which an insulating coating material containing a fluorine-based polyimide resin is used for forming an insulated wire, the relative dielectric constant thereof is from 2.3 to 2.8 and it is possible to obtain lower relative dielectric constant than that of a typical insulating film for a winding wire, thereby suppressing the amount of heat generation of the insulation covering and deterioration caused by heat.

As another example, an inverter surge resistant insulated wire has been proposed in which thickening of an insulation layer in order to increase partial discharge inception voltage is realized without decreasing adhesion strength between a conductor and an enamel layer (see, e.g., Japanese patent No. 4177295). In the insulated wire described in Japanese patent No. 4177295, the partial discharge inception voltage and the adhesion strength between the conductor and the enamel layer are both ensured by having a baked enamel layer on the conductor and an extruded covering resin layer provided on the outer side thereof and the adhesion force between the baked enamel layer and the extruded covering resin layer is strengthened by further interposing an adhesive layer therebetween.

As still another example, a multilayer insulated wire has been proposed in which an insulation layer is composed of two or more extruded covering layers excellent in heat resistance and chemical resistance (see, e.g., WO2005/106898).

### SUMMARY OF THE INVENTION

It can be assumed that the insulation covering containing a fluorine-based polyimide resin described in JP-A-2002-56720 has low adhesion with the conductor. Therefore, there are concerns that a phenomenon occurs in which an insulation covering is separated from a conductor due to severe processing stress during, e.g., a coil forming process, etc., (looseness of cover). The looseness of cover is a cause of breakdown.

On the other hand, it can be assumed that the insulated wire disclosed in Japanese patent No. 4177295 allows the extruded covering resin layer to be thickened to increase the partial discharge inception voltage. However, since properties of a resin composition and a forming method are greatly different between the baked enamel layer and the extruded covering resin layer, there are problems that the manufacturing process is likely to be complicated and it is likely to increase the manufacturing cost. In addition, when the adhesive layer is interposed between the baked enamel layer and the extruded covering resin layer to ensure adhesion therebetween, the manufacturing cost is further increased.

Meanwhile, in the multilayer insulated wire described in WO2005/106898, a thermoplastic resin is used for the two or more extruded covering layers and there is the same problem as the insulated wire described in Japanese patent No. 4177295 that it is necessary to avoid complexity of the manufacturing process and an increase in the manufacturing cost.

Accordingly, it is an object of the invention to provide an insulated wire that has higher partial discharge inception voltage and is excellent in heat resistance and adhesion, and a method of manufacturing the insulated wire.

(1) According to one embodiment of the invention, an insulated wire comprises:

a conductor; and

an insulation covering layer around the conductor,

wherein the insulation covering layer comprises a resin composition containing a resin (A) comprising at least one of a polyphenylene sulfide resin and a polyetheretherketone resin and a resin (B) containing a polyethylene, and

wherein the resin composition has a storage elastic modulus at 150° C. of not less than 1×10⁵ Pa and not more than 1×10⁹ Pa, and a storage elastic modulus at 300° C. of not less than 1×10⁴ Pa and not more than 1×10⁸ Pa.

In the above embodiment (1) of the invention, the following modifications and changes can be made.

(i) The resin composition further comprises a resin (C) containing an ethylene-glycidyl methacrylate copolymer.

(ii) The resin (A), the resin (B) and the resin (C) are mixed in the resin composition at a weight ratio of (A):(B):(C)=not less than 30 and not more than 60: not less than 35 and not more than 65: more than 0 and not more than 5.

(2) According to another embodiment of the invention, a method of manufacturing an insulated wire comprises:

extruding a resin composition on an outer periphery of a conductor to form an extruded covering layer around the conductor, the resin composition comprising a resin (A) comprising at least one of a polyphenylene sulfide resin and a polyetheretherketone resin, and a resin (B) containing a polyethylene, and having a storage elastic modulus at 150° C. of not less than 1×10⁵ Pa and not more than 1×10⁹ Pa and a storage elastic modulus at 300° C. of not less than 1×10¹ Pa and not more than 1×10⁸ Pa; and

thermally-treating the extruded covering layer at a predetermined thermal treatment temperature that is higher than a melting point or a glass-transition point of the resin (A).

In the above embodiment (2) of the invention, the following modifications and changes can be made.

(iii) The predetermined thermal treatment temperature is not less than 250° C. and not more than 300° C.

(iv) The method further comprises:

irradiating an electron beam on the extruded covering layer that is thermally-treated in the thermal treating, thereby crosslinking the resin composition.

### EFFECTS OF THE INVENTION

According to one embodiment of the invention, an insulated wire can be provided that has higher partial discharge inception voltage and is excellent in heat resistance and adhesion, and a method of manufacturing the insulated wire can be provided as well.

### BRIEF DESCRIPTION OF THE DRAWINGS

Next, the present invention will be explained in more detail in conjunction with appended drawings, wherein;

FIG. 1 is a schematic view showing an example of a typical insulated wire in an embodiment of the present invention;

FIG. 2 is a schematic view showing another example of the insulated wire; and

FIG. 3 is a schematic view showing still another example of the insulated wire.

### DETAILED DESCRIPTION OF THE PREFERRED EMBODIMENTS

A preferred embodiment of the invention will be specifically described below in conjunction with the appended drawings.

### Summary of the Embodiments

An insulated wire in the present embodiment is characterized in that an insulated wire is provided with a conductor and an insulation covering layer made of a predetermined resin composition and formed around the conductor wherein the resin composition contains a resin (A) formed of at least one of a polyphenylene sulfide resin and a polyetheretherketone resin and a resin (B) containing polyethylene and has a storage elastic modulus at 150° C. of not less than 1×10⁵ Pa and not more than 1×10⁹ Pa and a storage elastic modulus at 300° C. of not less than 1×10⁴ Pa and not more than 1×10⁸ Pa.

Here, the storage elastic modulus is a value obtained by the following measurement. A 0.5 mm-thick sheet of a resin composition is made by pressing, samples are cut out from the Sheet so as to have a width of about 5 mm and are placed at a chuck interval of 20 mm, and measurement is carried out using a viscoelastic measuring apparatus (DV5A-200, manufactured by IT Keisoku Seigyo Co., Ltd.) at a frequency of 1 Hz while increasing a temperature from ambient temperature at a rate of 10° C./min.

### Embodiment

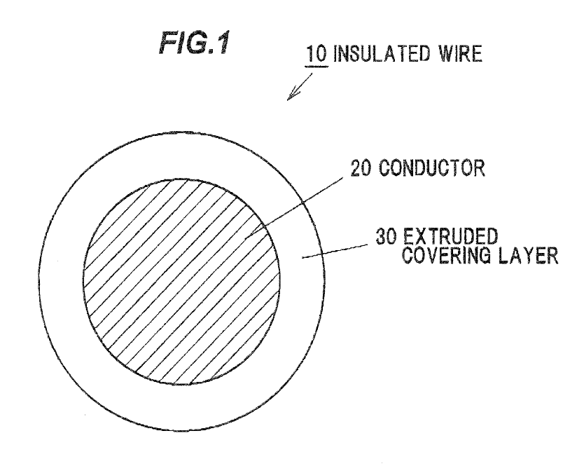

FIG. 1 is a cross sectional view showing an insulated wire in the embodiment of the invention. In FIG. 1 the entirety of a typical insulated wire 10 in the present embodiment is indicated by the reference numeral 10. As a basic structure, the insulated wire 10 has a conductor 20 and an extruded covering layer 30,

Conductor

The conductor 20 may be a single wire made of e.g., copper or copper alloy, or may be formed by twisting plural copper wires or plural copper alloy wires.

As the copper, it is possible to use, e.g., oxygen-free copper and low oxygen copper with low oxygen content, etc.

FIG. 1 shows an example in which a cross sectional shape of the conductor 20 is circular. It is obviously not limited to the illustrated example, and the cross sectional shape of the conductor 20 may be various shapes, e.g., a rectangular cross section, etc. Note that, the rectangular cross section includes a rectangle with rounded corners.

The diameter of the conductor 20 is set to, e.g., about 1 mm. In addition, it is possible to arbitrarily set the diameter of the conductor 20 depending on the implementation status.

Extruded Covering Layer

The extruded covering layer 30 is formed of a predetermined resin composition exhibiting a certain insulation property and is provided on a surface of the conductor 20.

The resin composition contains at least a resin (A) formed of at least one of a polyphenylene sulfide resin and a polyetheretherketone resin, a resin (B) containing polyethylene and a resin (C) containing ethylene-glycidyl methacrylate copolymer.

A storage elastic modulus of the resin composition at 150° C. is not less than 1×10⁵ Pa and not more than 1×10⁹ Pa, preferably not less than 2×10⁵ Pa and not more than 1×10⁹ Pa, and more preferably not less than 2.5×10⁵ Pa and not more than 1×10⁹ Pa. In addition, a storage elastic modulus of the resin composition at 300° C. is not less than 1×10⁴ Pa and not more than 1×10⁸ Pa, preferably not less than 5×10⁴ Pa and not more than 1×10⁸ Pa, and more preferably not less than 9×10⁴ Pa and not more than 1×10⁸ Pa.

It is preferable that the resin composition further contain the resin (C) containing ethylene-glycidyl methacrylate copolymer.

When the resin composition contains the resin (A), the resin (B) and the resin (C) as is described above, it is preferable that the resin (A), the resin (B) and the resin (C) be mixed in the resin composition at a weight ratio within a range of A:B:C=not less than 30 and not more than 60: not less than 35 and not more than 65: more than 0 and not more than 5, and preferably, not less than 35 and not more than 45; not less than 50 and not more than 60: more than 0 and not more than 5.

Each function of the resin (A), the resin (B) and the resin (C) will be described. Since the resin (A) is formed of at least one of a polyphenylene sulfide resin and a polyetheretherketone resin, high heat resistance and high mechanical characteristics are exhibited. On the other hand, since the resin (B) is formed of polyethylene including high density polyethylene, etc., high electrical characteristics such as higher partial discharge inception voltage and high mechanical characteristics are exhibited. Therefore, the resin composition containing the resin (A) and the resin (B) can achieve all of high heat resistance, high mechanical characteristics and high electrical characteristics at a high level. In addition, the resin (C) contains ethylene-glycidyl methacrylate copolymer, and thus has a function of sufficiently finely dispersing the resin (A) and the resin (B) in the resin composition.

The reason for the above-mentioned ratio A:B:C will be described. When the weight ratio of the resin (A) is less than 30 parts by weight, the amount of then rein A is too small and sufficient heat resistance may not be obtained. On the other hand, when the weight ratio of the resin (A) is more than 60, the amount of then rein B is too small and sufficiently high partial discharge inception voltage may not be obtained. When the weight ratio of the resin (C) is more than 5, sufficient mechanical characteristics may not be obtained. Therefore, the above-mentioned weight ratio is preferable in order to obtain heat resistance, sufficiently high partial discharge inception voltage and high mechanical characteristics.

In addition, it is preferable that antioxidant, copper inhibitor, lubricant and colorant, etc., be added to the resin composition when needed.

Meanwhile, it is preferable that the extruded covering layer 30 be formed of a resin composition which is crosslinked by electron beam irradiation.

In addition, it is preferable that the thickness of the extruded covering layer 30 be set to within a range of about not less than 70 μm to not more than 100 μm

Intended Use, etc., of Insulated Wire

The insulated wire 10 is preferably used for a coil of e.g., an electric equipment such as rotating machine or transformer. More specifically, the insulated wire 10 is suitable for a coil formed by connecting end portions of plural insulated wires 10 each deformed into a substantially U-shape and having a rectangular cross section using a welding method such as Tungsten Inert Gas (TIG) welding.

The coil formed by welding and connecting end portions of plural insulated wires 10 deformed into a substantially U-shape may be a coil formed by connecting end portions of plural insulated wires 10 each partially deformed into a step shape so that a portion of the insulated wire 10 protruding from a stator core in an axial direction thereof (also called coil end) has plural step portions along a circumferential direction of the stator core.

Method of Manufacturing Insulated Wire

Next, an example of a method of manufacturing the insulated wire 10 in the present embodiment will be described. The present manufacturing method includes at least a cover step and a thermal treatment step. It is preferable that the method of manufacturing the insulated wire 10 further include an electron beam irradiation step.

(1) Cover Step

In the cover step, an outer periphery of the conductor 20 is covered with the extruded covering layer 30 by extruding the above-mentioned predetermined resin composition on the outer periphery of the conductor 20. In the cover step, the resin composition is extrusion-fed in a molten state of being heated to about 300° C. On the other hand, a surface temperature of the conductor 20 to be an extrusion feed recipient is also similar to the temperature of the resin composition melted by heating.

(2) Thermal Treatment Step

In the thermal treatment step, the extruded covering layer 30 is thermally-treated at a predetermined thermal treatment temperature which is higher than a melting point or a glass-transition point (or temperature) of the resin (A). A general apparatus such as electric furnace, burner warm air heater or induction heating apparatus is used as a thermal treatment apparatus. The predetermined thermal treatment temperature is preferably, e.g., a temperature 100° C. higher than the glass-transition temperature (Tg) of the resin (A). For example, the preferred predetermined thermal treatment temperature is not less than 250° C. and not more than 300° C. The thermal treatment temperature is determined to be not more than 300° C. since the extruded covering layer 30 may be deformed at more than 300° C. The thermal treatment time is preferably from 10 seconds to 1 minute.

(3) Electron Beam Irradiation Step

In the electron beam irradiation step, the resin composition is crosslinked by irradiating an electron beam on the thermally-treated extruded covering layer 30. When a coil of an electric equipment is formed using the insulated wire 10, the electron beam irradiation step is carried out before forming the coil,

### Effects of the First Embodiment

The present embodiment achieves the following effects.

(a) In the insulated wire 10 of the present embodiment, since at least the resin (A) and the resin (B) are contained, it is possible to achieve all of high heat resistance, high mechanical characteristics and high electrical characteristics at a high level.

(b) In addition, the resin composition is set to have a storage elastic modulus at 150° C. of not less than 1×10⁵ Pa and not more than 1×10⁹ Pa and a storage elastic modulus at 300° C. of not less than 1×10⁴ Pa and not more than 1×10⁸ Pa, therefore, in the extruded covering layer 30, while good insulating properties are maintained in the high temperature environment of 260° C., a sharp decline in elastic modulus does not occur even in the higher temperature environment of not less than 260° C. and not more than 300° C. and it is thus possible to maintain the insulating properties even in the higher temperature environment,

(c) Since the resin composition further contains the resin (C) containing ethylene-glycidyl methacrylate copolymer, it is possible to sufficiently finely disperse the resin (A) and the resin (B) in the resin composition.

(d) Since the resin (A), the resin (B) and the resin (C) are mixed in the resin composition at a weight ratio within a range of A:B:C=not less than 30 and not more than 60: not less than 35 and not more than 65: more than 0 and not more than 5, it is possible to obtain the insulated wire 10 having high heat resistance and high partial discharge inception voltage.

(e) In the cover step, the resin composition is extrusion-fed in a molten state of being heated to about 300° C. On the other hand, the surface temperature of the conductor 20 to be an extrusion feed recipient is also similar to the temperature of the resin composition melted by heating (e.g., a temperature of about 300° C.). Meanwhile, the thickness of the extruded covering layer 30 formed of the resin composition is thinner than the diameter of the conductor 20, hence, heat capacity of the conductor 20 is greater than that of the insulation covering. Thus, it is considered that, in the conventional art, rapid thermal contraction of the extruded covering layer 30 occurs at an interface between the conductor 20 and the extruded covering layer 30, which decreases adhesion therebetween. That is, in the present embodiment, it is possible to improve also adhesion between the conductor 20 and the extruded covering layer 30 since the thermal treatment step is provided after the cover step.

A method of heating the conductor 20 as an extrusion feed recipient to a temperature similar to the temperature of the resin composition melted by heating includes a method using a hot air heater and an induction heating method, and the induction heating should be used so that an oxide film is less likely to be formed on an surface of the conductor 20 at the time of heating.

(f) Since the thermal treatment is carried out in the thermal treatment step after the cover step at the temperature of not less than 250° C. and not more than 300° C. which is 100° C. or more higher than the glass-transition temperature (Tg) of the resin (A), crystals of the resin (A) are melted, mobility of resin molecule in the resin composition is enhanced and it is possible to reduce a distance between the surface of the conductor 20 and the resin molecule, hence, it is possible to significantly improve adhesion between the conductor 20 and the extruded covering layer 30. As a result, even in the case of small diameter (e.g., self-diameter) bending of the insulated wire 10, it is possible to prevent wrinkles from occurring on the insulated wire 10 and also to improve abrasion resistance of the insulated wire 10.

That is, the thermal treatment carried out in the above-mentioned thermal treatment temperature range allows higher partial discharge inception voltage (e.g., not less than 1300 Vp) than the conventional partial discharge inception voltage (900 Vp) to be realized without decreasing adhesion between the conductor 20 and the extruded covering layer 30.

(g) The electron beam irradiation step is carried out after the thermal treatment step. This is because the molecular structure of the resin composition becomes more likely to be crosslinked since the resin (A) and the resin (B) are mixed, which allows low dose of electron beam irradiation to crosslink the resin composition.

Since the resin composition is crosslinked by electron beam irradiation, deformation of the extruded covering layer 30 can be suppressed when the extruded covering layer 30 is exposed to a molding temperature which is higher than the melting point of the resin composition having the resin (A) and the resin (B) mixed thereto. As a result, extrusion moldability of the extruded covering layer 30 becomes good and it is possible to ensure the insulation performance of the extruded covering layer 30 and also to further improve the heat resistance of the insulated wire 10 after extrusion molding.

As obvious from the above description, although the insulated wire 10 of the invention and the manufacturing method thereof have been described based on the embodiment, various configurations can be made within the scope of the technical idea of the invention and the following first and second modifications can be made.

Modifications

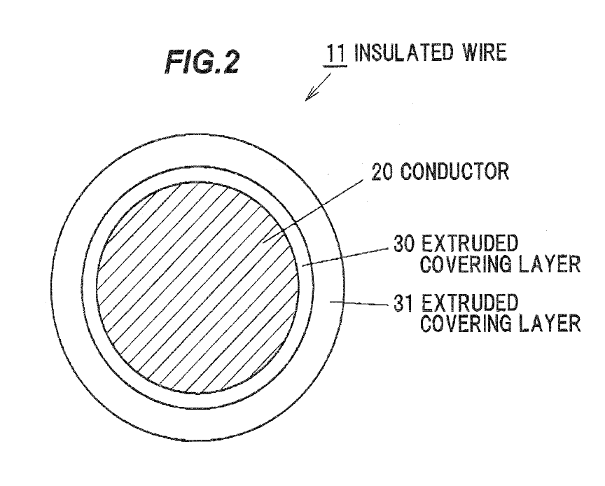

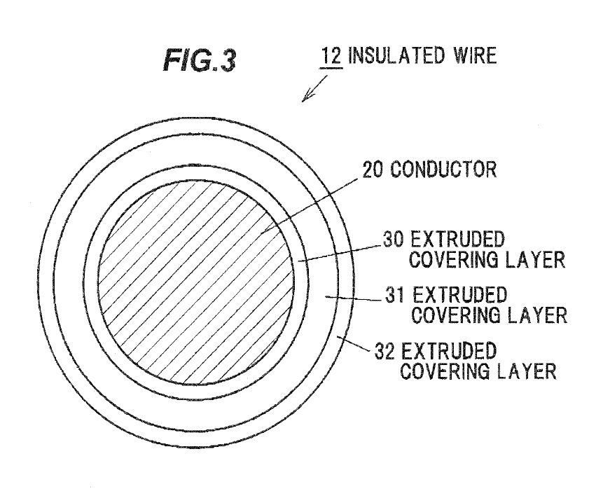

Next, two modifications of the present embodiment will be described in reference to FIGS. 2 and 3.

First Modification

Firstly, the first modification will be described in reference to FIG. 2,

A major difference between the first modification and the embodiment is a layer structure of the extruded covering layer. The embodiment is a single layer structure using only the extruded covering layer 30. The first modification is a two-layer structure composed of a first extruded covering layer 30 as a lower layer and a second extruded covering layer 31 as an upper layer.

Therefore, the detailed description about the common members and structures will be omitted, and substantially the same members as those in the embodiment are denoted by the same names and reference numerals in FIG. 2.

As shown in FIG. 2, an insulated wire 11 in the first modification is configured such that the first extruded covering layer 30 is extruded on and covers the conductor 20 and the second extruded covering layer 31 is further extruded on and covers the first extruded covering layer 30.

The second extruded covering layer 31 is formed after the thermal treatment step for the first extruded covering layer 30. An extrusion temperature of the second extruded covering layer 31 is set to a temperature to the extent of not melting the first extruded covering layer 30.

In addition, a nonillustrated lubricant layer may be separately formed on the outer peripheral surface of the second extruded covering layer 31.

Resins of e.g., thermoplastic polyamide-imide, thermoplastic polyimide, polyetheretherketone, polyether imide or polyphenylene sulfide are preferable as the second extruded covering layer 31.

The diameter of the conductor 20 is set to, e.g., about 1 mm. Alternatively, it is possible to arbitrarily set the diameter of the conductor 20 depending on the implementation status.

It is preferable that the thickness of the first extruded covering layer 30 as a lower layer be about not less than 30 μm. On the other hand, it is preferable that the thickness of the second extruded covering layer 31 as an upper layer be about not less than 20 μm. Then, it is preferable that the total thickness of both the extruded covering layers 30 and 31 be set to within a range of about not less than 70 μm to not more than 100 μm.

Effects of the First Modification

The first modification achieves the following effects in addition to the effects of the embodiment.

In the first modification, a two-layer structure composed of the extruded covering layers 30 and 31 is employed as described above. Accordingly, it is possible to further improve abrasion resistance of the insulated wire 11 as compared to the embodiment.

As a result, even when an external force such as tension or shear stress is strongly applied to the insulated wire 11 in, e.g., wire winding work at the time of forming a coil of electric equipment using the insulated wire 11, it is possible to prevent breakage of cover or fine cracks, etc., from occurring on the surface of the second extruded covering layer 31 as the outermost layer.

Second Modification

Next, the second modification will be described in reference to FIG. 3.

A major difference between the second modification and the embodiment is a layer structure of the extruded covering layer. In the embodiment, the extruded covering layer has a single layer structure using a single extruded covering layer 30. The second modification is a three-layer structure composed of a first extruded covering layer 30 as a lower layer, a second extruded covering layer 31 as a middle layer and a third extruded covering layer 32 as an upper layer.

Therefore, the detailed description about the common members and structures will be omitted, and substantially the same members as those in the embodiment are denoted by the same names and reference numerals in FIG. 3.

As shown in FIG. 3, an insulated wire 12 in the second modification is configured such that the first extruded covering layer 30, the second extruded covering layer 31 and the third extruded covering layer 32 are extruded in this order to cover the conductor 20.

The second extruded covering layer 31 and the third extruded covering layer 32 are formed after the thermal treatment step for the first extruded covering layer 30. Each extrusion temperature of the second extruded covering layer 31 and the third extruded covering, layer 32 is set to a temperature to the extent of not melting the first extruded covering layer 30.

In addition, a non-illustrated lubricant layer may be separately formed on the outer peripheral surface of the third extruded covering layer 32.

Resins of e.g., thermoplastic polyamide-imide, thermoplastic polyimide, polyetheretherketone, polyether imide or polyphenylene sulfide are preferable for the second extruded covering layer 31 and the third extruded covering layer 32.

It is preferable that each thickness of the first extruded covering layer 30 as a lower layer and the third extruded covering layer 32 as an upper layer be about not less than 20 μm. On the other hand, it is preferable that the thickness of the second extruded covering layer 31 as a middle layer be about not less than 30 μm. Then, it is preferable that the total thickness of all of the extruded covering layers 30, 31 and 32 be set to within a range of about not less than 70 μm to not more than 100 μm.

Effects of the Second Modification

The second modification achieves the following effects in addition to the effects of the embodiment.

In the second modification, a three-layer structure composed of the extruded covering layers 30, 31 and 32 is employed as described above. Accordingly, it is possible to improve abrasion resistance and to further prevent breakage of cover, fine cracks, crazing, wrinkles or looseness of cover from occurring on the third extruded covering layer 32 as the outermost layer, etc., as compared to the embodiment and the first modification.

As a result, even when an external force such as tension or shear stress is strongly applied to the insulated wire 12 in, e.g., wire winding work at the time of forming a coil of electric equipment using the insulated wire 12, it is possible to prevent breakage of cover or fine cracks, etc., from occurring on the surface of the third extruded covering layer 32 as the outermost layer.

### Example 1

As a further specific embodiment of the invention, insulated wires in Examples and Comparative Examples will be described in detail below in reference to Table 1. It should be noted that Examples are typical examples of the insulated wire of the invention and the invention is not limited to thereto.

Samples of insulated wires in Examples 1 to 5 and Comparative Examples 1 to 4 having various types of the extruded covering layers were made. The samples were compared and evaluated for outer appearance, elastic modulus, partial discharge inception voltage, adhesion and heat resistance. Components of the extruded covering layer, treatment conditions and thickness of the extruded covering layer in each sample are summarized in following Table 1.

TABLE 1

| | | | Examples | | | | | Comparative Examples | | | |
|---|---|---|---|---|---|---|---|---|---|---|---|
| | | | 1 | 2 | 3 | 4 | 5 | 1 | 2 | 3 | 4 |
| Composition | Polyphenylene sulfide | | 30 | 35 | 40 | 45 | 60 | 100 | | | 30 |
| | (MFR = 1.0 g/10 min) | | | | | | | | | | |
| | High-density polyethylene | | | 65 | 60 | | | 35 | | 100 | |
| | (MFR = 0.8 g/10 min, | | | | | | | | | | |
| | d = 0.951) | | | | | | | | | | |
| | High-density polyethylene | | | | | 55 | 55 | | | | 100 |
| | (MFR = 0.04 g/10 min, | | | | | | | | | | |
| | d = 0.954) | | | | | | | | | | |
| | Ethylene-glycidyl | | 5 | 5 | 5 | | 5 | | | | 5 |
| | methacrylate copolymer | | | | | | | | | | |
| | (GMA = 12%, | | | | | | | | | | |
| | MFR = 3 g/10 min) | | | | | | | | | | |
| | Polystyrene | | | | | | | | | | 65 |
| | (flexural modulus = | | | | | | | | | | |
| | 2.5 GPa) | | | | | | | | | | |
| Thickness of extruded covering layer (μm) | | | 100 | 100 | 100 | 100 | 100 | 100 | 100 | 100 | 100 |
| Thermal treatment temperature (° C.) | | | 250 | 280 | 280 | 280 | 280 | 300 | 250 | 250 | 280 |
| Evaluation | Outer appearance | | ◯ | ◯ | ◯ | ◯ | ◯ | ◯ | X | X | ◯ |
| result | Elastic modulus | 150° C. | 2.7 × 10⁵ | 5.3 × 10⁵ | 3.3 × 10⁶ | 2.7 × 10⁶ | 3.0 × 10⁶ | 2.4 × 10⁸ | 5.3 × 10⁴ | 2.5 × 10⁵ | 8.8 × 10⁷ |
| | (GPa) | 260° C. | 1.1 × 10⁵ | 1.9 × 10⁵ | 1.2 × 10⁶ | 7.1 × 10⁵ | 2.0 × 10⁵ | 6.9 × 10⁷ | 8.4 × 10² | 3.5 × 10⁴ | 1.8 × 10⁷ |
| | | 300° C. | 9.2 × 10⁴ | 1.4 × 10⁵ | 2.0 × 10⁵ | 9.4 × 10⁴ | 2.4 × 10⁴ | 2.9 × 10 | 1.4 × 10³ | 4.9 × 10⁴ | 3.9 × 10² |
| | Partial discharge inception | | 1550 | 1530 | 1520 | 1500 | 1410 | 1100 | — | — | 1370 |
| | voltage(V) | | | | | | | | | | |
| | Evaluation of adhesion | | ⊚ | ⊚ | ⊚ | ⊚ | ⊚ | ◯ | — | — | ⊚ |
| | First heat | 260° C. | ◯ | ◯ | ◯ | ◯ | ◯ | Δ | — | — | ◯ |
| | resistance | 300° C. | ◯ | ◯ | ◯ | ◯ | ◯ | X | — | — | X |
| | evaluation | | | | | | | | | | |

| | | | | | | | | | |
|---|---|---|---|---|---|---|---|---|---|
| Second heat resistance | ◯ | ◯ | ◯ | ◯ | ◯ | X | — | — | X |
| evaluation | | | | | | | | | |

Manufacturing of Insulated Wire

Plural copper wires each having an outer diameter of 1.25 mm were prepared as a conductor and nine types of resin compositions respectively containing components shown in Table 1 were extruded on the copper wires using an extruder to form an extruded covering layer.

After forming, the extruded covering layer, the samples of Examples 1 to 5 and Comparative Examples 1 to 4 were thermally-treated by passing through an electric furnace at a preset temperature of 250 to 300° C.

Then, after the thermal treatment through the electric furnace at a preset temperature of not less than 250° C. and not more than 300° C., the outer appearance of each sample was evaluated. The “outer appearance” of the sample in which the extruded covering layer maintains the thickness of about 100 μm was defined as “◯ (passed the test)” and the “outer appearance” of the sample in which the thickness of the extruded covering layer is non-uniform or varies was defined as “X (failed the test)”.

Then, the following measurements and tests were conducted on the samples of Examples 1 to 5 and Comparative Examples 1 to 4. Note that, since Comparative Examples 2 and 3 failed in the evaluation of the outer appearance, measurement of partial discharge inception voltage, evaluation of adhesion and each heat resistance evaluation were not conducted.

Measurement of Elastic Modulus (Storage Elastic Modulus)

The elastic modulus was measured by the following procedure. A 0.5 mm-thick sheet of a resin composition shown in Table 1 was made by pressing, samples were cut out from the sheet so as to have a width of about 5 mm and were placed at a chuck interval of 20 mm, and elastic moduli (storage elastic moduli) were measured at 150° C., 260° C. and 300° C. using a viscoelastic measuring apparatus (DV5A-200, manufactured by IT Keisoku Seigyo Co., Ltd.) at a frequency of 1 Hz while increasing a temperature from ambient temperature at a rate of 10° C./min. The pressed sheets in Examples 1 to 5 and Comparative Example 1 were molded at 300° C. and those in Comparative Examples 2 to 4 were molded at 150° C.

Evaluation of Adhesion

The adhesion was evaluated by conducting a sudden tensile test in accordance with HS C 3003. As a result of the sudden tensile test, the sample in which length of looseness (separation) of the extruded covering layer from a rupture point is not more than 2 mm was defined as “⊚ (excellent)”, the sample in which length of looseness of the extruded covering layer from a rupture point is not less than 2 mm and not more than 20 mm was defined as “◯ (passed the test)” and the sample in which length of looseness of the extruded coveting layer from a rupture point is more than 20 mm was defined as “X (failed the test)”.

Measurement of Partial Discharge Inception Voltage

The partial discharge inception voltage was measured by the following procedure. Firstly, two 500 mm-long insulated wires were cut out and were twisted together while applying tension of 39N (4 kgf), thereby preparing a twisted pair sample having six twisted portions within 120 mm at the middle portion.

Next, 10 mm of the extruded covering layer at an end portion of the sample was removed by Abisofix. Then, the sample was kept in a constant-temperature oven at 120° C. for 30 minutes in order to dry the extruded covering layer and was subsequently left in a desiccator for 18 hours until reaching room temperature.

The partial discharge inception voltage was measured using a partial discharge measuring system (DAC-6024, manufactured by Soken Electric Co., Ltd). Under the measurement conditions of a measurement temperature of 25° C. and an atmosphere with a relative humidity of 50%, voltage was applied to the twisted pair sample while increasing the voltage from 50 Hz at not less than 10 V/s and not more than 30 V/s.

In the measurement of partial discharge inception voltage, voltage at which electric discharge of 50 pC occurs 50 times per second in the twisted pair sample is defined as the partial discharge inception voltage (V),

First Heat Resistance Evaluation The first heat resistance was tested and evaluated by the following procedure. Firstly, two 500 mm-long insulated wires were cut out and were twisted together while applying tension of 39N (4 kgf), thereby preparing a twisted pair sample having six twisted portions within 120 mm at the middle portion.

Then, the sample was heat-aged by heating and holding at 260° C. for 2 hours or at 300° C. for 2 hours using an aging testing machine (Geer oven STD60P, manufactured by Toyo Seiki Co., Ltd.).

Following this, the twisted pair sample was wound around a round bar (a winding bar) having a diameter of 4 mm and presence of cracks on the extruded covering layer was examined using an optical microscope of 50 times magnification. The sample without cracks, etc. (e.g., crack, crazing, wrinkle) was defined as “◯ (passed the test)”, the sample with only crazing was defined as “Δ (failed the test)” and the sample with cracks was defined as “X (failed the test)”.

Note that, the crazing refers to a state in which the surface of the extruded covering layer is locally recessed and the crack means a crack which reaches the surface of the conductor.

Second Heat Resistance Evaluation

The second heat resistance was tested and evaluated by the following procedure. Firstly, two 500 mm-long insulated wires were cut out and were twisted together while applying tension of 39N (4 kgf), thereby preparing a twisted pair sample having six twisted portions within 120 mm at the middle portion.

Then, the sample was heat-aged by heating and holding at 350° C. for 5 minutes using an aging testing machine (Geer oven STD60P, manufactured by Toyo Seiki Co., Ltd.). After that, the partial discharge inception voltage was measured by the partial discharge inception voltage test. The case where a decrease in the partial discharge inception voltage is less than 20% of the measured value in the partial discharge inception voltage measurement test was evaluated as “◯” and the case where a decrease in the partial discharge inception voltage is more than 20% of the measured value in the partial discharge inception voltage measurement test was evaluated as “X”,

Comprehensive Evaluation

As shown in Table 1, in the insulated wires of Examples 1 to 5, the predetermined resin composition constituting the extruded covering layer contains the resin (A) formed of polyphenylene sulfide resin. The predetermined resin composition is set to have a storage elastic modulus at 150° C. of not less than 1×10⁵ Pa and not more than 1×10⁹ Pa and a storage elastic modulus at 300° C. of not less than 1×10⁴ Pa and not more than 1×10⁸ Pa.

The evaluation result in table 1 revealed that this allows the insulated wire to maintain insulation properties even in the high temperature environment of 260° C. Especially in the insulated wire of Example 3, since the elastic modulus of the resin composition is not less than 1×10⁶ Pa in a temperature range from ambient temperature to 260° C. and also not less than 1×10⁵ Pa in a temperature range of more than 260° C. to not more than 300° C., insulation properties in the high temperature environment are ensured with higher reliability. It is presumed that the reason why the high elastic modulus is maintained even at 300° C. is that the effect of high density polyethylene having relatively high elastic modulus is exerted even at the temperature higher than the melting points of polyphenylene sulfide resin and high density polyethylene since a polymer alloy is formed from polyphenylene sulfide resin and high density polyethylene.

In addition, it was confirmed that the insulated wires in Examples 1 to 5 have high partial discharge inception voltage of not less than 1300 V. Furthermore, in the adhesion and the first and second heat resistance heat resistance evaluations, it was confirmed that the insulated wires in Examples 1 to 5 have necessary and sufficient characteristics.

On the other hand, in Comparative Example 1, since the extruded covering layer is formed of the resin composition made of only the polyphenylene sulfide resin (A), adhesion was not sufficient and also the heat resistance was evaluated as failed. In addition, since the polyethylene resin (B) excellent in electrical characteristics is not contained in the resin composition, the partial discharge inception voltage was lower than those in Examples 1 to 5.

In Comparative Examples 2 and 3, the extruded covering layer is formed of the resin composition made of only the polyethylene resin (B) and the polyphenylene sulfide resin (A) excellent in heat resistance is not contained in the resin composition. Therefore, the extruded covering layer was melted and separated at the stage of thermal-treating thereof at not less than 250° C. and not more than 300° C. This resulted in poor appearance of the extruded covering layer and it was not possible to conduct evaluations of partial discharge inception voltage, heat resistance and adhesion.

In other words, it was demonstrated that the insulated wires in Examples 1 to 5 of the invention have high partial discharge inception voltage and heat resistance without decreasing adhesion between the conductor and the extruded covering layer.

Meanwhile, in the invention, the polyethylene contained in the resin (B) preferably has a melt flow rate (NUR) of not more than 1 g per 10 minutes. For measuring the MFR, for example, a method in accordance with K7210 is employed.

By using the resin (B) containing such polyethylene of which MFR is not more than 1 g per 10 minutes, a decrease in elastic modulus of the resin composition at high temperature can be suppressed. As a result, it is possible to suppress deformation of the extruded covering layer even at a molding temperature which is higher than the melting point of the resin composition, and accordingly, it is possible to improve extrusion moldability of the extruded covering layer. Accordingly, it is also possible to further improve heat resistance of the insulated wire. In other words, the extruded covering layer is less likely to melt even in a high temperature region of not less than 250° C. and it is possible to maintain insulation properties of the insulated wire at a high level.

Although the copper conductor having a circular cross section is used in Examples, it is also possible to obtains an insulated wire with high partial discharge inception voltage by using a copper conductor having, e.g., a rectangular cross section in the same manner as Examples.

As obvious from the above, it should be noted that all combinations of the features described in the embodiment, modifications and examples are not necessary to solve the problem of the invention, and various configurations can be made within the scope of the technical idea of the invention.

What is claimed is:

1. An insulated wire, comprising:
a conductor; and
an insulation covering layer around the conductor,
wherein the insulation covering layer comprises a resin composition containing a resin (A) comprising at least one of a polyphenylene sulfide resin and a polyetheretherketone resin and a resin (B) containing a polyethylene, and
wherein the resin composition has a storage elastic modulus at 150° C. of not less than 1×10⁵ Pa and not more than 1×10⁹ Pa, and a storage elastic modulus at 300° C. of not less than 1×10⁴ Pa and not more than 1×10⁸ Pa.

2. The insulated wire according to claim 1, wherein the resin composition further comprises a resin (C) containing an ethylene-glycidyl methacrylate copolymer.

3. The insulated wire according to claim 2, wherein the resin (A), the resin (B) and the resin (C) are mixed in the resin composition at a weight ratio of (A):(B):(C)=not less than 30 and not more than 60: not less than 35 and not more than 65: more than 0 and not more than 5.

4. A method of manufacturing an insulated wire, comprising:
extruding a resin composition on an outer periphery of a conductor to form an extruded covering layer around the conductor, the resin composition comprising a resin (A) comprising at least one of a polyphenylene sulfide resin and a polyetheretherketone resin, and a resin (B) containing a polyethylene, and having a storage elastic modulus at 150° C. of not less than 1×10⁵ Pa and not more than 1×10⁹ Pa and a storage elastic modulus at 300° C. of not less than 1×10⁴ Pa and not more than 1×10⁸ Pa; and
thermally-treating the extruded covering layer at a predetermined thermal treatment temperature that is higher than a melting point or a glass-transition point of the resin (A).

5. The method according to claim 4, wherein the predetermined thermal treatment temperature is not less than 250° C. and not more than 300° C.

6. The method according to claim 4, further comprising:
irradiating an electron beam on the extruded covering layer that is thermally-treated in the thermal treating, thereby crosslinking the resin composition.
